(19) United States
(12) Patent Application Publication
(10) Pub. No.: US 2024/0005416 A1
(43) Pub. Date: Jan. 4, 2024

(54) ELECTRONIC DEVICE AND METHOD FOR MANAGING PERSONAL RESOURCE

(71) Applicant: Trinion America, Inc., San Diego, CA (US)

(72) Inventor: Moon Sun Chung, Seoul (KR)

(21) Appl. No.: 18/330,168

(22) Filed: Jun. 6, 2023

(30) Foreign Application Priority Data
Jun. 29, 2022 (KR) 10-2022-0079851

(51) Int. Cl. G06Q 50/00; G06Q 10/1093; G06Q 40/02; G06F 3/0482; G06F 3/0484

(52) U.S. Cl. CPC G06Q 50/01; G06Q 10/1095; G06Q 40/02; G06F 3/0482; G06F 3/0484

(57) ABSTRACT

An electronic device includes a display; a storage configured to store a plurality of contacts; and a processor. The processor is configured to display the plurality of contacts on the display; receive a first user input for selecting one contact from among the plurality of contacts; and display activity information related to the selected contact and contact history information related to the selected contact on the display, based on the first user input, wherein the activity information includes an activity name, schedule information, place information, asset information, and grade information related to the selected contact, and wherein the asset information includes information on income and expenditure breakdowns related to the activity information.

### CROSS-REFERENCE TO RELATED APPLICATION

This application is based upon and claims the benefit of priority from Korean Patent Application No. 10-2022-0079851, filed on Jun. 29, 2022, the entire contents of which are incorporated herein by reference.

### TECHNICAL FIELD

The present disclosure relates to an electronic device and a method for managing personal resources.

### BACKGROUND

According to diversification of electronic devices, the electronic devices are implemented in the form of multimedia players having complex functions, for example, functions of capturing photos or videos, reproducing music or video files, playing games, receiving broadcasts, or making calls. For example, a user may receive various types of services through applications installed in the electronic device. Such an electronic device may include a display and display a screen related to functions on the basis of the display.

These days, humans can manage various personal resources (for example, time, personal connections, and assets) through an IT infrastructure, and efficiently managing limited personal resources has become important. Recently, due to the development of smart devices, various applications for managing personal resources have been released.

### SUMMARY

When a contact application is used to manage personal connections among various personal resources, only one-dimensional information such as a counterpart's name and phone number may be generally stored and managed.

According to various embodiments of the present disclosure, an electronic device may include a display; a storage configured to store a plurality of contacts; and a processor, wherein the processor is configured to: display the plurality of contacts on the display; receive a first user input for selecting one contact from among the plurality of contacts; and display activity information related to the selected contact and contact history information related to the selected contact on the display, based on the first user input, wherein the activity information includes an activity name, schedule information, place information, asset information, and grade information related to the selected contact, and wherein the asset information includes information on income and expenditure breakdowns related to the activity information.

The activity information according to various embodiments is a planned activity or a performed activity, and if the activity information is the performed activity, the activity information includes edges having a specific color.

If the activity information according to various embodiments is the planned activity, the activity information does not include edges.

The processor according to various embodiments is configured to further display, if the activity information related to the selected contact includes a plurality of pieces of activity information, an average value of grade information of the plurality of pieces of activity information.

The processor according to various embodiments is configured to further display at least one contact that has performed an activity with the selected contact among the plurality of contacts, based on the plurality of pieces of activity information.

The processor according to various embodiments is configured to display an activity generation screen on the display, based on a second user input for generating new activity information related to the selected contact.

The processor according to various embodiments is configured to: identify, when a financial transfer is identified from a financial application, a counterpart of the financial transfer; identify, when the identified counterpart corresponds to the selected contact, activity information related to the selected contact, based on the financial transfer; and register the financial transfer in information on income and expenditure breakdowns of the identified activity information.

The processor according to various embodiments is configured to: display, when the financial transfer is identified from the financial application, a popup window for inputting information on the financial transfer; and identify information on a counterpart of the financial transfer based on the information input through the popup window.

The processor according to various embodiments is configured to further display personal information of the selected contact based on the first user input, and the personal information includes a name, a phone number, a photo, and propensity information of the selected contact.

The processor according to various embodiments is configured to further display latest news information related to the selected contact based on the first user input.

According to various embodiments of the present disclosure, a method of managing personal resources using an electronic device, includes: displaying a plurality of contacts; receiving a first user input for selecting one contact from among the plurality of contacts; and displaying activity information related to the selected contact and contact history information related to the selected contact on a display, based on the first user input, wherein the activity information includes an activity name, schedule information, place information, asset information, and grade information related to the selected contact, and wherein the asset information includes information on income and expenditure breakdowns related to the activity information.

The activity information according to various embodiments is a planned activity or a performed activity, and if the activity information is the performed activity, the activity information includes edges having a specific color.

According to various embodiments, if the activity information is the planned activity, the activity information does not include edges.

If the activity information related to the selected contact includes a plurality of pieces of activity information, the method according to various embodiments includes displaying an average value of grade information of the plurality of pieces of activity information.

The method of according to various embodiments further includes displaying at least one contact that has performed an activity with the selected contact among the plurality of contacts, based on the plurality of pieces of activity information.

The method of according to various embodiments further includes displaying an activity generation screen on the display based on a second user input for generating new activity information related to the selected contact.

The method of according to various embodiments further includes: identifying, when a financial transfer is identified from a financial application, a counterpart of the financial transfer; identifying, when the identified counterpart corresponds to the selected contact, activity information related to the selected contact based on the financial transfer; and registering the financial transfer in information on income and expenditure breakdowns of the identified activity information.

The method of according to various embodiments further includes: displaying, when the financial transfer is identified from the financial application, a popup window for inputting information on the financial transfer; and identifying information on a counterpart of the financial transfer based on the information input through the popup window.

The method of according to various embodiments further includes displaying personal information of the selected contact based on the first user input, wherein the personal information includes a name, a phone number, a photo, and propensity information of the selected contact.

The method of according to various embodiments further includes displaying latest news information related to the selected contact based on the first user input.

### BRIEF DESCRIPTION OF DRAWINGS

The accompanying drawings, which are incorporated in and constitute a part of the specification, illustrate embodiments of the present disclosure.

FIG. 1 is a block diagram of an electronic device according to various embodiments of the present disclosure.

FIG. 2 illustrates an execution screen of an application for managing personal resources according to various embodiments of the present disclosure.

FIGS. 3A to 3C illustrate detailed contact screens of the application according to various embodiments of the present disclosure.

FIG. 4 illustrates a contact sharing screen of the application according to various embodiments of the present disclosure.

FIG. 5 illustrates a detailed contact screen of the application according to various embodiments of the present disclosure.

FIG. 6 illustrates a contact generation screen of the application according to various embodiments of the present disclosure.

FIG. 7 is a flowchart illustrating an operation of the electronic device according to various embodiments of the present disclosure.

FIG. 8 is a flowchart illustrating an operation of the electronic device according to various embodiments of the present disclosure.

FIG. 9 is a flowchart illustrating an operation of the electronic device according to various embodiments of the present disclosure.

### DETAILED DESCRIPTION

Embodiments of the present disclosure are illustrated for describing the technical spirit of the present disclosure. The scope of the claims according to the present disclosure is not limited to the embodiments described below or to the detailed descriptions of these embodiments.

All technical or scientific terms used herein have meanings that are generally understood by a person having ordinary knowledge in the art to which the present disclosure pertains, unless otherwise specified. The terms used herein are selected for only more clear illustration of the present disclosure, and are not intended to limit the scope of claims in accordance with the present disclosure.

The expressions “include”, “provided with”, “have” and the like used herein should be understood as open-ended terms connoting the possibility of inclusion of other embodiments, unless otherwise mentioned in a phrase or sentence including the expressions.

A singular expression can include meanings of plurality, unless otherwise mentioned, and the same is applied to a singular expression stated in the claims.

The terms “first”, “second”, etc. used herein are used to identify a plurality of components from one another, and are not intended to limit the order or importance of the relevant components.

The term “unit” used in these embodiments means a software component or hardware component, such as a field-programmable gate array (FPGA) and an application specific integrated circuit (ASIC). However, a “unit” is not limited to software and hardware and it may be configured to be an addressable storage medium or may be configured to run on one or more processors. For example, a “unit” may include components, such as software components, object-oriented software components, class components, and task components, as well as processors, functions, attributes, procedures, subroutines, segments of program codes, drivers, firmware, micro-codes, circuits, data, databases, data structures, tables, arrays, and variables. Functions provided in components and “unit” may be combined into a smaller number of components and “units” or further subdivided into additional components and “units.”

The expression “based on” used herein is used to describe one or more factors that influences a decision, an action of judgment or an operation described in a phrase or sentence including the relevant expression, and this expression does not exclude additional factor influencing the decision, the action of judgment or the operation.

When a certain component is described as “coupled to” or “connected to” another component, this should be understood as having meaning that the certain component may be coupled or connected directly to the other component or that the certain component may be coupled or connected to the other component via a new intervening component.

Hereinafter, embodiments of the present disclosure will be described with reference to the accompanying drawings. In the accompanying drawings, like or relevant components are indicated by like reference numerals. In the following description of embodiments, repeated descriptions of the identical or relevant components will be omitted. However, even if a description of a component is omitted, such a component is not intended to be excluded in an embodiment.

Although process steps, method steps, algorithms, and the like have been described in a successive order with regard to the flowcharts illustrated in the present disclosure, such processes, methods, and algorithms may be configured to operate in any appropriate order. In other words, steps of processes, methods, and algorithms described in various embodiments of the present disclosure are not necessarily performed in the order described in the present disclosure. In addition, some steps may be described as being performed asynchronously, such steps may be performed synchronously in other embodiments. In addition, an example of a process by illustration in the drawings does not mean that the exemplified processes exclude other changes and modifications related thereto, does not mean that the exemplified process or any of its steps is essential to one or more of various embodiments of the present disclosure, and does not mean that the exemplified process is preferable.

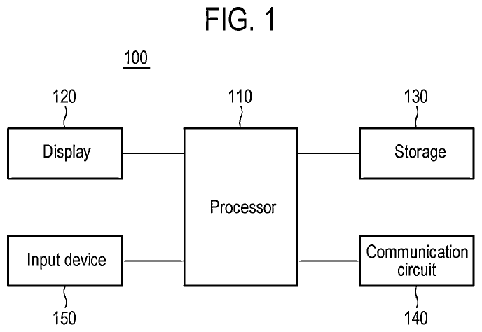

FIG. 1 is a block diagram of an electronic device 100 according to various embodiments of the present disclosure.

Referring to FIG. 1, the electronic device 100 according to various embodiments may include a processor 110, a display 120, a storage 130, a communication circuit 140, and an input device 150. Although some of the elements illustrated in FIG. 1 are omitted or replaced, there will be no problem in implementing various embodiments disclosed in the present disclosure.

According to various embodiments, the processor 110 of the electronic device 100 may be an element capable of controlling each element of the electronic device 100 and/or performing calculations or data processing related to communication. The processor 110 may be operatively connected to elements of the electronic device 100. The processor 110 may load commands or data received from other elements of the electronic device 100 to a memory (not shown), process the commands or data stored in the memory, and store resultant data.

The display 120 according to various embodiments may display various screens based on the control of the processor 110. The display 120 may be implemented in the form of a touch sensor panel (TSP) capable of recognizing contact or proximity (for example, hovering) of various external objects. For example, the display 120 may include a capacitive sensor in order to recognize contact or proximity of various external objects. The capacitive sensor may include a plurality of capacitors and may apply electrical signals to the capacitors. The capacitors may charge and discharge electric charges in response to the application of the electrical signals. When the electrical signals are applied to the capacitors, the capacitors may be charged according to the size of voltages of the electrical signals. The display 120 may receive a user's touch input based on signals collected by the capacitive sensor.

The storage 130 according to various embodiments may store various pieces of data used by at least one element of the electronic device 100. For example, the storage 130 may store a plurality of contacts. For example, the storage 130 may store various pieces of information corresponding to the plurality of contacts (for example, personal information, conduct information (or activity information, action information), personal connection information, schedule information, contact history information, and asset information).

The communication circuit 140 according to various embodiments may establish a communication channel with an external device and transmit and receive various pieces of data to and from the external device. According to various embodiments, the communication circuit 140 may include a cellular communication module and may be configured to be connected to a cellular network (for example, 3G, LTE, 5G, Wibro, or Wimax). According to various embodiments, the communication circuit 140 may include a short-range communication module to transmit and receive data to and from the external device through short-range communication (for example, Wi-Fi, Bluetooth, Bluetooth low energy (BLE), or UWB), but is not limited thereto.

The input device 150 according to various embodiments may receive commands or data to be used by an element (for example, the processor 110) of the electronic device 100 from the outside (for example, a user) of the electronic device 100. The input device 150 may include, for example, a microphone, a mouse, a keyboard, or a digital pen. According to various embodiments, the input device 150 may be implemented as an element separated from the display 120 or as a single element with the display 120. For example, the input device 150 may be implemented as a touch sensor panel of the display 120. The input device 150 may be implemented in various forms capable of receiving a user input and is not limited to the examples.

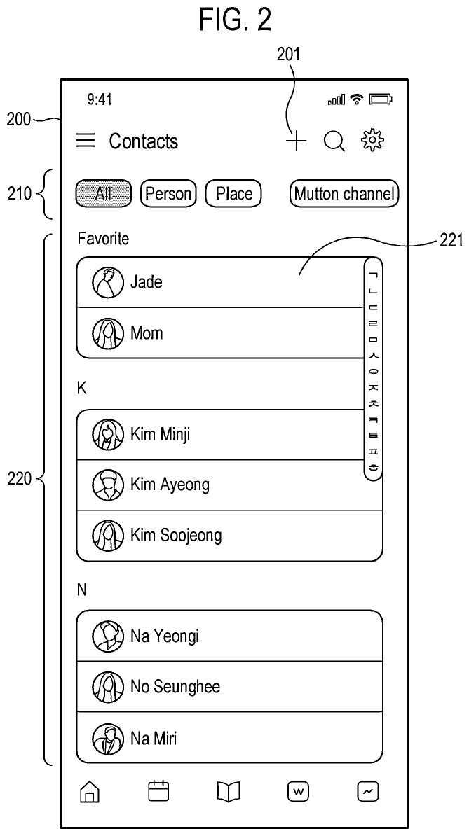

FIG. 2 illustrates an execution screen of an application according to various embodiments of the present disclosure. Specifically, FIG. 2 illustrates a main screen 200 of a personal connection management function of the application for managing personal resources. In FIG. 2, personal connection information may be contact information. That is, the personal connection information and the contact information may match each other. Further, the contact information may be contact information of a person or contact information of a place.

Referring to FIG. 2, the processor 110 of the electronic device 100 according to various embodiments of the present disclosure may execute an application for managing personal resources (personal resource planning) The processor 110 may display various execution screens of the application through the display 120. When a personal connection management function is selected in the application for managing personal resources, the processor 110 may display the main screen 200 for the personal connection-managing function. The main screen 200 may include a classification tab 210 and a contact display area 220.

The processor 110 according to various embodiments may display a home screen icon, a schedule management icon, a personal connection management icon, an asset management icon, and a report management icon in one area of the main screen 200. The processor 110 may display the main screen 200 for the personal connection management function in response to receiving a user input for selecting the personal connection management icon.

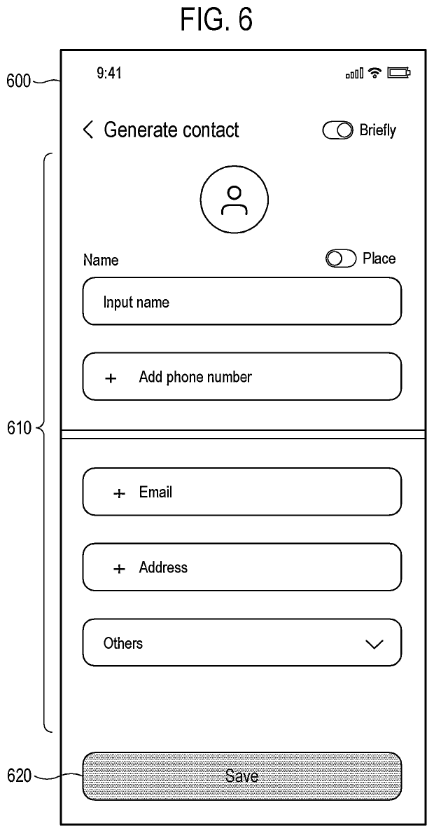

The processor 110 according to various embodiments may display an addition icon 201 for adding (generating) a new contact. The processor 110 may display a screen for adding a contact based on receiving a user input for selecting the addition icon 201. The user may input information on a new contact into the screen for adding the contact. The newly added contact may be stored in the storage 130. A method of adding the contact is described below with reference to FIG. 6. The processor 110 according to various embodiments may display a plurality of contacts in the contact display area 220. For example, the processor 110 may display a plurality of contacts in the contact display area 220 of the main screen 200 based on the plurality of contacts stored in the storage 130. The processor 110 may display names and images of persons corresponding to the plurality of contacts along with the contacts. For example, the processor may display a contact 221 of “Jade” in one area of the contact display area.

The processor 110 according to various embodiments may filter and display only contact information related to persons or contact information related to places through the classification tab 210. The processor 110 may display only contacts related to persons among the plurality of contacts based on a user input for selecting a person. The processor 110 may display only contacts related to places among the plurality of contacts based on a user input for selecting a place. The processor 110 may display a button channel screen including a recommended button channel and a user's button channel based on a user input for selecting a button channel. The button channel may mean, for example, a channel in which registered contact information is collected by a server that manages the application.

The processor 110 according to various embodiments may display a name search icon in the main screen 200. For example, the user may input a name of a contact for which the user desires to search through the name search icon and conveniently find the same. The processor 110 according to various embodiments may receive a user input for selecting one contact among the plurality of displayed contacts. The processor 110 may display a detailed screen for displaying and managing various pieces of information related to the selected contact in response to receiving one contact among the plurality of contacts.

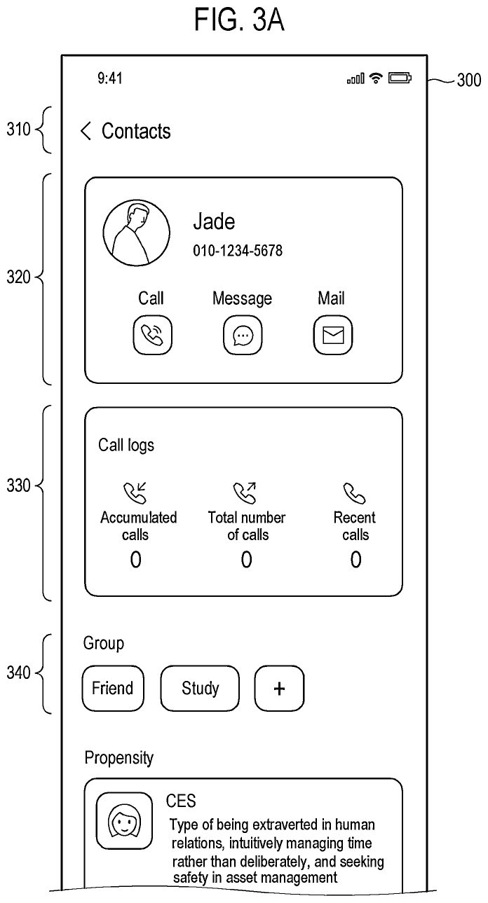

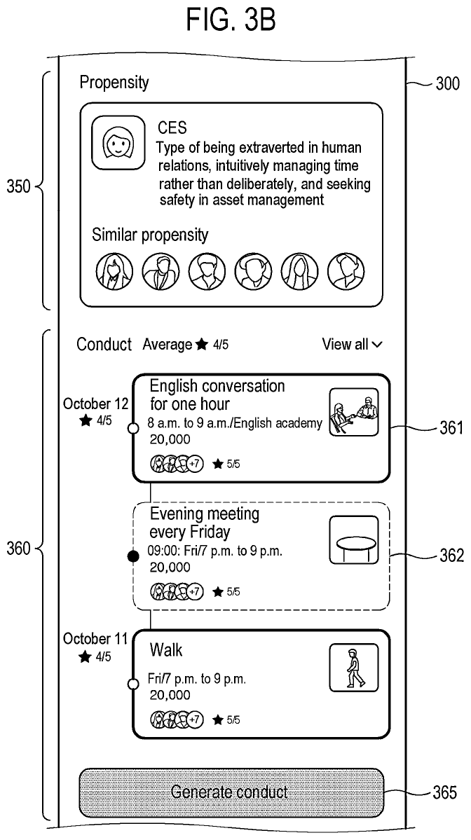

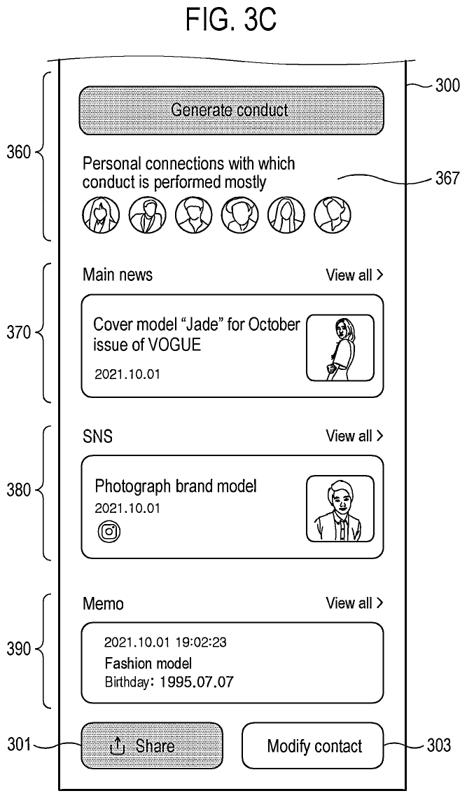

FIGS. 3A to 3C illustrate a detailed contact screen 300 of the application according to various embodiments of the present disclosure. Specifically, FIGS. 3A to 3C illustrate the detailed contact screen 300 for a selected contact when one of the plurality of contacts displayed on the main screen 200 for the personal connection management function of FIG. 2 is selected. In FIGS. 3A to 3C, it is assumed that the contact of “Jade” is selected from among the plurality of contacts displayed on the main screen of FIG. 2 for convenience of description. The detailed contact screen 300 may include, for example, a plurality of pages or one page which can be scrolled and moved.

Referring to FIGS. 3A to 3C, with respect to a plurality of contacts, an application for managing personal resources according to various embodiments may collectively display various pieces of information related to the plurality of contacts in the detailed screen 300.

The detailed contact screen 300 according to various embodiments may include a return area 310, a profile area 320, a call log area 330, a group area 340, a propensity area 350, a conduct area 360, a main news area 370, an SNS area 380, and a memo area 390.

When a user input for selecting a return icon displayed in the return area 310 is received, the processor 110 according to various embodiments may return to the main screen 200 of FIG. 2.

The processor 110 according to various embodiments may display a profile related to the selected contact in the profile area 320. If the selected contact is contact information of a person, the processor 110 may display a name, a phone number, or an image of the corresponding personal connections (contact) in the profile area 320. The processor 110 may further display a communication application icon for communication with the selected contact in the profile area 320. The communication application may include at least one of, for example, a call application, a short message service (SMS) application, a multimedia messaging service (MMS) application, an email application, an instant message application, and an SNS application. When a user input for selecting the communication application is received, the processor 110 may execute the selected communication application. For example, when the user input for selecting the call application is received, the processor 110 may make a call to a phone number of Jade by executing the selected call application.

The processor 110 according to various embodiments may display the total number of accumulated calls and the number of recent calls in the call log area 330. The number of accumulated calls may be, for example, the number of calls obtained by summing incoming/outgoing calls and missed calls. The total number of calls may be the number of calls obtained by summing up incoming/outgoing calls. The recent calls may be calls made within a predetermined period (for example, recent 30 days).

The processor 110 according to various embodiments may display information on a group including the personal connections (contact) in the group area 340. For example, the processor 110 may display information indicating that the corresponding personal connection belongs to a “friend” group and a “study” group in the group area 340. The processor 110 according to various embodiments may display a propensity of the corresponding personal connection in the propensity area 350. The processor 110 may also display information on other personal connections having a propensity similar to (or same as) the propensity of the corresponding personal connection in the propensity area 350.

The processor 110 according to various embodiments may display at least one conduct (or conduct information) related to the corresponding personal connection in the conduct area 360. The conduct disclosed in this disclosure may be information on various schedules or activities. For example, the contact may include information on daily activities, information on business activities, and information on meeting activities. As used herein, the term “conduct” may mean or refer to an “activity” or “action.” For example, the term “activity information” may be used in place or or instead of the term “conduct information.” The conduct may include a conduct name, schedule information, place information, asset information, and grade information. The schedule information may include a spent time and participant information, the asset information may be an income breakdown or an expenditure breakdown, and the grade information may be scores for evaluating the corresponding conduct. For example, the conduct may include information on at least one schedule or activity among daily life, meal, coffee, meditation, walk, jogging, golf, horse-riding, surfing, business, presentation, meeting, lesson, search, cooking, repair, research, drawing, and cycle racing.

The conduct may correspond to a planned conduct or a performed conduct. The planned conduct may refer to a conduct planned to be performed in the future. For example, the planned conduct may include an activity planned to be performed on a specific day, a schedule planned to be performed with a specific person, and an activity planned to be performed according to a specific period. The performed conduct may refer to an already performed conduct. For example, the performed conduct is a past conduct and may include actual performance details of the corresponding conduct. For example, the performed conduct may be additionally generated by inputting information on whether the planned conduct is performed, grade, and actual performance details.

According to various embodiments, the performed conduct and the planned conduct may be differently displayed to be distinguished from each other. For example, edges of the planned conduct may be displayed with a dotted line, and edges of the performed conduct may be displayed with thick solid lines. For example, the planned conduct may not include edges, and the performed conduct may include edges having a specific color (for example, purple). The distinguished display method is not limited thereto and may include various display methods. For example, as illustrated in FIG. 3B, a performed conduct 361 may include thick solid line edges, and a planned conduct 362 may include dotted line edges, so as to be distinguished from each other.

Asset information included in the conduct may include an income breakdown or an expenditure breakdown. If the conduct corresponds to the performed conduct, the performed conduct may include an income breakdown or an expenditure breakdown generated for performing the corresponding conduct. For example, the performed conduct 361 may include information on expenditure breakdowns 20,000 won actually generated for performing the conduct of “English conversion for one hour.” If the conduct corresponds to the planned conduct, the planned conduct may include a planned income breakdown or expenditure breakdown. For example, the planned conduct 362 may include information on expenditure breakdowns 20,000 won to be generated for performing “evening meeting every Friday.”

The processor 110 may add (store) the income and expenditure breakdowns to (in) the conduct related to the contact selected based on the user input. The processor 110 may display a detailed conduct screen of the selected contact based on a user input for registering the income and expenditure breakdowns in the conductor for the selected contact. The processor 110 may register the income and expenditure breakdowns for the selected conduct based on a user input for inputting at least one of a date, an amount of money, a type (for example, income or expenditure), and content within the detailed conduct screen. For example, if 20,000 won is paid for performing the conduct, which is performed along with a person corresponding to the selected contact, the user may input the conduct performance cost of 20,000 won as the expenditure breakdowns into income/expenditure information of the selected conduct.

The processor 110 according to various embodiments may identify a financial transfer from a financial application and store the corresponding financial transfer in income and expenditure breakdowns of the conduct related to the selected contact. When the financial transfer is identified from the financial application, the processor 110 may identify a counterpart of the financial transfer. If the identified counterpart corresponds to the selected contact, the processor 110 may identify the conduct related to the selected contact based on the financial transfer. The processor 110 may store the corresponding financial transfer in information on income and expenditure breakdowns of the identified conduct. For example, if the financial transfer corresponds to a transfer of sending money to the identified contact by the user, the financial transfer may be registered in the expenditure breakdowns of the identified conduct. For example, if the financial transfer corresponds to a transfer of receiving money from the identified contact by the user, the financial transfer may be registered in the income breakdowns of the identified conduct.

If the conduct information related to the selected contact includes a plurality of pieces of activity information, the processor 110 may register the corresponding financial transfer in income and expenditure breakdowns of the selected conduct based on a user input of selecting one of the plurality of identified conducts. For example, the processor 110 may receive the user input of selecting one conduct related to the corresponding financial transfer from among the plurality of identified conducts. In this case, the processor 110 may register the corresponding financial transfer in the income and expenditure breakdowns of the one selected conduct based on the received user input.

The financial application may include, for example, a bank application. For example, if a financial transfer of sending 10,000 won to an account of a specific person is generated through the bank application, the processor 110 may identify who the specific person corresponding to a counterpart of the financial transfer is. If the identified counterpart is a person corresponding to the selected contact, the processor 110 may identify at least one conduct related to the corresponding person. The user may select one conduct related to the corresponding financial transfer from among at least one identified conduct. In this case, the processor 110 may register the corresponding financial transfer in the selected conduct.

When the financial transfer is identified from the financial application, the processor 110 may display a popup window for inputting information on the financial transfer. The popup window may include, for example, a window for inputting a counterpart or detailed content of the financial transfer. The processor 110 may identify counterpart information or content of the generated financial transfer based on the information input through the popup window. The processor 110 may identify at least one related conduct based on a date, an amount of money, and a type of the financial transfer identified from the financial application and the counterpart and the content of the financial transfer input through the popup window.

The processor 110 may further display a conduct generation icon 365 to newly generate a new conduct related to the corresponding personal connection. At least one conduct may be information on schedules or activities with the person corresponding to the selected contact. The processor 110 may display detailed content of the corresponding conduct in response to a user input of selecting the corresponding conduct.

The processor 110 may further display an average of grades of at least one conduct displayed in the conduct area 360. The user may assign grades to a plurality of conducts and assign emotional grades (for example, good, bad, expectation, and difficulty) to the plurality of conducts. For example, the user may give a grade of 4.5 points output of 5 points to a specific conduct. Further, the processor 110 may calculate an average of grades of at least one conduct and display the average in the conduct area 360.

The processor 110 may further display information 367 on at least one personal connection with which the conduct is mostly performed in the conduct area 360. The processor 110 may display information 367 on other personal connections with which the corresponding personal connections performed the conduct based on at least one piece of conduct information related to the corresponding personal connections. For example, the processor 110 may display the information 367 on personal connections corresponding to a preset number in the order of the largest number of performances of the conduct with the corresponding personal connections.

The processor 110 according to various embodiments may display news information related to the corresponding personal connections in the news area 370. The processor 110 according to various embodiments may display an SNS sharing icon in the SNS area 380. The processor 110 according to various embodiments may display a memo related to the corresponding personal connection in the memo area 390.

The processor 110 may share information on the corresponding personal connections with other personal connections in response to receiving a user input of selecting the sharing icon 301. The processor 110 according to various embodiments may modify contact information of the corresponding personal connections through the icon 303 for modifying the contact. When a user input of selecting the contact modification icon 303 is received, the processor 110 may display a screen for editing detailed information of the contact.

The processor 110 according to various embodiments may identify the number of contacts made with the selected contact for a configured reference period from the communication application. For example, when the user makes a call to the selected contact once through the call application for a configured reference period, the processor 110 may count one corresponding to the number of contacts made with the selected contact. For example, when messages are transmitted to the selected contact two times through a short message service application for a configured reference period, the processor 110 may count two corresponding to the number of contacts made with the selected contact.

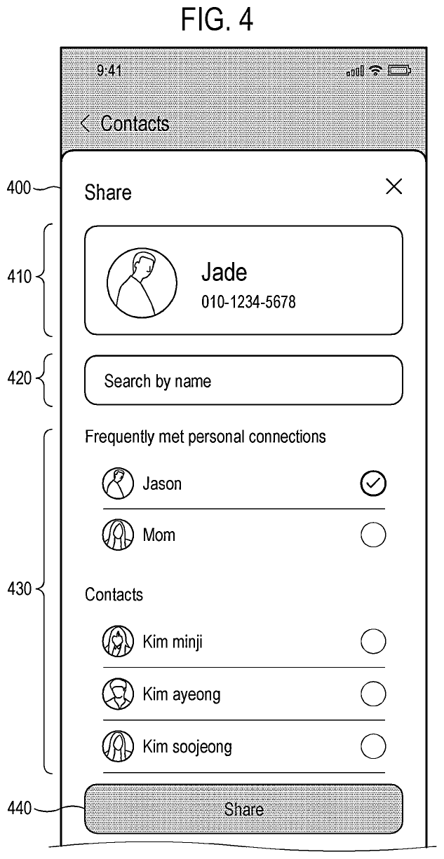

FIG. 4 illustrates a contact sharing screen 400 of the application according to various embodiments of the present disclosure. When the user input of selecting the sharing icon 301 of FIG. 3C is received, the processor 110 may display a contact sharing screen 400. Specifically, it will be described by assuming that the selected contact of “Jade” is shared.

The contact sharing screen 400 according to various embodiments may include a contact card area 410 for displaying short information of the contact to be shared, a contact search area 420, a contact list area 430, and a sharing icon 440. The user may search for another contact with which the corresponding contact is shared through the contact search area 420 and select one of at least one contact displayed in the contact list area 430. The user may select the sharing icon 440 to share the corresponding contact with another contact.

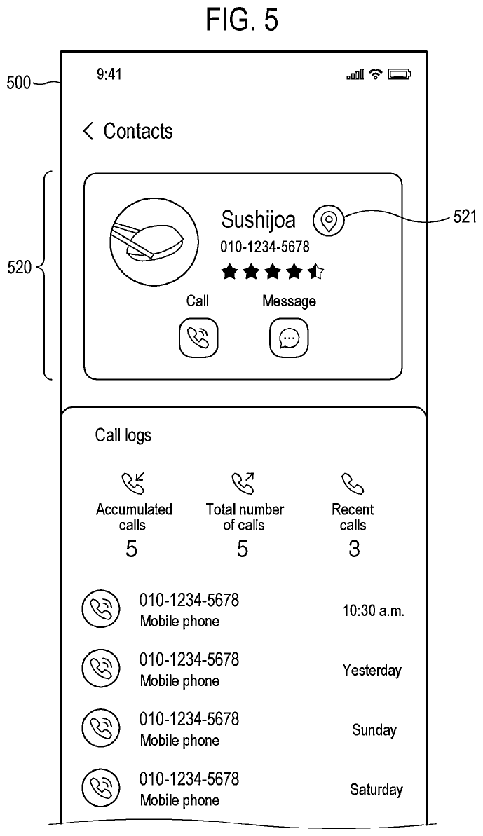

FIG. 5 illustrates a detailed contact screen 500 of the application according to various embodiments of the present disclosure.

According to various embodiments, contact information may include contact information for persons or contact information for places. If contact information is contact information for places as illustrated in FIG. 5, the processor 110 may include a name, a phone number, an image, and a location icon 521 of the corresponding place in a profile area 520. The processor 110 may display the location of the corresponding place based on a user input of selecting the location icon 521. For example, the processor 110 may display the location of the corresponding place by executing a map application.

FIG. 6 illustrates a contact generation screen 600 of the application according to various embodiments of the present disclosure. If the user input of selecting the addition icon 201 of FIG. 2 is received, the processor 110 may display the contact generation screen 600. The contact generation screen may include an input area 610 for inputting a name and a phone number. The user may input a name and a phone number of a person corresponding to the contact to be newly generated (added) through the input area 610. The user may further input an email or an address through the input area 610. After information on the contact to be generated is completely input into the contact generation screen 600, the user may select a save icon 620 to generate and store the new contact.

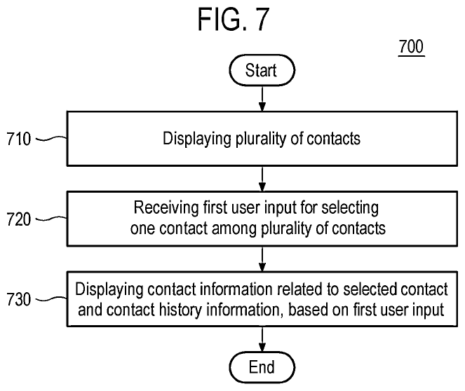

FIG. 7 is a flowchart illustrating an operation of the electronic device according to various embodiments of the present disclosure. Referring to the operation flowchart 700, the processor 110 of the electronic device 100 according to various embodiments may display a plurality of contacts through the display 120 in operation 710. If the application for managing personal resources is executed, the processor 110 may display a plurality of contacts in a main screen based on the plurality of contacts stored in the storage 130. If the application for managing personal resources is executed and a personal connection management function is selected in the application, the processor 110 may display a main screen including a plurality of contacts.

The processor 110 according to various embodiments may receive a first user input for selecting one contact from among the plurality of contacts in operation 720. For example, the processor 110 may receive a touch input for selecting one of the plurality of contacts displayed on the display 120 from the user. For example, the processor 110 may receive a user input of selecting one of the plurality of contacts displayed in the main screen.

The processor 110 according to various embodiments may display conduct information (or activity information) related to the selected contact and contact history information related to the selected contact on the display 120 based on the first user input in operation 730. The conduct information may include a conduct name, schedule information, place information, and grade information related to the selected contact. Asset information may include information on income and expenditure breakdowns of the conduct information.

The conduct information may correspond to a planned conduct (or a planned activity) or a performed conduct (or a performed activity). The planned conduct and the performed conduct may be displayed differently to be distinguished from each other. For example, the performed conduct may include edges having a specific color, and the planned conduct may not include edges.

According to various embodiments, if the conduct information related to the selected contact includes a plurality of pieces of conduct information, the processor 110 may further display an average value of grade information of the plurality of pieces of conduct information on the display 120. The processor 110 may further display at least one contact that has performed an activity with the selected contact among the plurality of contacts based on the plurality of pieces of conduct information.

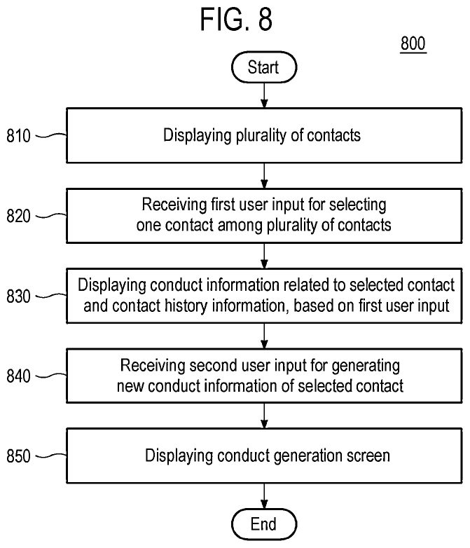

FIG. 8 is a flowchart illustrating an operation of the electronic device 100 according to various embodiments of the present disclosure. Description overlapping the description made with reference to FIG. 7 will be omitted. Referring to the operation flowchart 800, the processor 110 according to various embodiments may display a plurality of contacts on the display 120 in operation 810. The processor 110 according to various embodiments may receive a first user input for selecting one contact from among the plurality of contacts in operation 820. The processor 110 according to various embodiments may display contact information related to the selected contact and contact history information (or activity history information) related to the selected contact on the display 120 based on the first user input in operation 830.

The processor 110 according to various embodiments may receive a second user input for generating new conduct information for the selected contact in operation 840. For example, the processor 110 may receive the second user input of selecting a conduct generation icon for generating a new conduct related to the selected contact.

The processor 110 according to various embodiments may display a conduct generation screen (or an activity generation screen) based on the second user input in operation 850. The user may input a name of the conduct to be generated, schedule information, asset information, and other information (for example, photos, music, and memos) through the conduct generation screen. In this case, personal connection information related to the conduct to be generated may be automatically input as information on the selected contact. The user may generate (add) the new conduct related to the selected contact through the conduct generation screen.

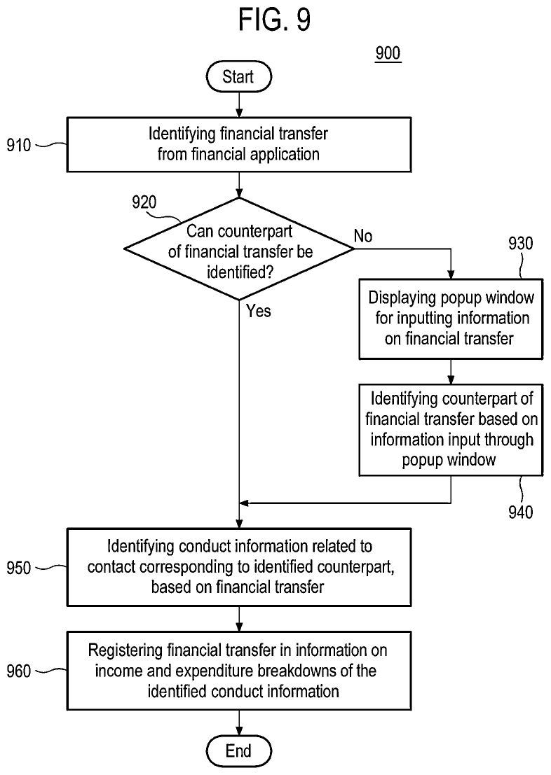

FIG. 9 is a flowchart illustrating an operation of the electronic device 100 according to various embodiments of the present disclosure.

Referring to the operation flowchart 900, the processor 110 according to various embodiments may identify a financial transfer from a financial application in operation 910. The financial application may include, for example, a bank application.

The processor 110 according to various embodiments may determine whether a counterpart of the financial transfer can be identified in operation 920.

If the counterpart of the identified financial transfer can be identified, the processor 110 may proceed to operation 950 (920—Yes), identify the counterpart of the generated financial transfer, and register (store) the corresponding financial transfer in income and expenditure breakdowns of the conduct related to the contact corresponding to the identified counterpart using the generated financial transfer. For example, if the name of the counterpart of the financial transfer matches one of the persons corresponding the plurality of stored contacts, the processor 110 may identify conduct information related to the corresponding contact using the generated financial transfer.

If the counterpart of the identified financial transfer cannot be identified, the processor 110 may proceed to operation 930 (920—No) and display a popup window for inputting information on the financial transfer. For example, if the name of the counterpart of the financial transfer does not match the persons corresponding to the plurality of contacts, the processor may display a popup window for inputting information on the financial transfer. The processor 110 according to various embodiments may identify information on the counterpart of the generated financial transfer based on information input through the popup window in operation 940.

The processor 110 according to various embodiments may identify conduct information related to the identified contact using the generated financial transfer in operation 950. The processor 110 according to various embodiments may register the financial transfer in information on income and expenditure breakdowns of the identified conduct information in operation 960.

If conduct information related to the selected contact includes a plurality of pieces of conduct information, the processor 110 may register the corresponding financial transfer in the income and expenditure breakdowns of the selected conduct based on a user input of selecting one conduct related to the corresponding financial transfer from among the plurality of conducts. For example, the processor 110 may receive the user input of selecting one conduct related to the corresponding financial transfer from among the plurality of identified conducts. In this case, the processor 110 may register the corresponding financial transfer in the income and expenditure breakdowns of the one selected conduct based on the received user input.

The electronic device according to various embodiments of the present disclosure can efficiently manage personal resources by combining counterparts' personal information (for example, names and phone numbers) and manage schedule information, contact history information, and income and expenditure information together in order to manage personal resources.

While the foregoing methods have been described with respect to particular embodiments, these methods may also be implemented as computer-readable code on a computer-readable recording medium. The computer-readable recording medium includes any kind of data storage devices that can be read by a computer system. Examples of the computer-readable recording medium includes ROM, RAM, CD-ROM, magnetic tape, floppy disk, optical data storage device and the like. Also, the computer-readable recording medium can be distributed to computer systems which are connected through a network so that the computer-readable code can be stored and executed in a distributed manner Further, the functional programs, code, and code segments for implementing the foregoing embodiments can easily be inferred by programmers in the art to which the present disclosure pertains.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An electronic device comprising:
a display;
a storage configured to store a plurality of contacts; and
a processor,
wherein the processor is configured to:
display the plurality of contacts on the display;
receive a first user input for selecting one contact from among the plurality of contacts; and
display activity information related to the selected contact and contact history information related to the selected contact on the display, based on the first user input,
wherein the activity information includes an activity name, schedule information, place information, asset information, and grade information related to the selected contact, and
wherein the asset information includes information on income and expenditure breakdowns related to the activity information.

2. The electronic device of claim 1, wherein the activity information is a planned activity or a performed activity, and
wherein if the activity information is the performed activity, the activity information includes edges having a specific color.

3. The electronic device of claim 2, wherein if the activity information is the planned activity, the activity information does not include edges.

4. The electronic device of claim 3, wherein if the activity information related to the selected contact includes a plurality of pieces of activity information, the processor is configured to further display an average value of grade information of the plurality of pieces of activity information.

5. The electronic device of claim 4, wherein the processor is configured to further display at least one contact that has performed an activity with the selected contact among the plurality of contacts, based on the plurality of pieces of activity information.

6. The electronic device of claim 1, wherein the processor is configured to display a activity generation screen on the display based on a second user input for generating new activity information related to the selected contact.

7. The electronic device of claim 1, wherein the processor is configured to:
identify, when a financial transfer is identified from a financial application, a counterpart of the financial transfer;
identify, when the identified counterpart corresponds to the selected contact, activity information related to the selected contact based on the financial transfer; and
register the financial transfer in information on income and expenditure breakdowns of the identified activity information.

8. The electronic device of claim 7, wherein the processor is configured to:
display, when the financial transfer is identified from the financial application, a popup window for inputting information on the financial transfer; and
identify information on a counterpart of the financial transfer based on the information input through the popup window.

9. The electronic device of claim 1, wherein the processor is configured to further display personal information of the selected contact based on the first user input, and
wherein the personal information includes a name, a phone number, a photo, and propensity information of the selected contact.

10. The electronic device of claim 9, wherein the processor is configured to further display latest news information related to the selected contact based on the first user input.

11. A method of managing personal resources using an electronic device, the method comprising:
displaying a plurality of contacts;
receiving a first user input for selecting one contact from among the plurality of contacts; and
displaying activity information related to the selected contact and contact history information related to the selected contact on a display, based on the first user input,
wherein the activity information includes an activity name, schedule information, place information, asset information, and grade information related to the selected contact, and
wherein the asset information includes information on income and expenditure breakdowns related to the activity information.

12. The method of claim 11, wherein the activity information is a planned activity or a performed activity, and
wherein if the activity information is the performed activity, the activity information includes edges having a specific color.

13. The method of claim 12, wherein if the activity information is the planned activity, the activity information does not include edges.

14. The method of claim 13, further comprising, if the activity information related to the selected contact includes a plurality of pieces of activity information, displaying an average value of grade information of the plurality of pieces of activity information.

15. The method of claim 14, further comprising displaying at least one contact that has performed an activity with the selected contact among the plurality of contacts, based on the plurality of pieces of activity information.

16. The method of claim 11, further comprising displaying an activity generation screen on the display based on a second user input for generating new activity information related to the selected contact.

17. The method of claim 11, further comprising:
identifying, when a financial transfer is identified from a financial application, a counterpart of the financial transfer;
identifying, when the identified counterpart corresponds to the selected contact, activity information related to the selected contact based on the financial transfer; and
registering the financial transfer in information on income and expenditure breakdowns of the identified activity information.

18. The method of claim 17, further comprising:
displaying, when the financial transfer is identified from the financial application, a popup window for inputting information on the financial transfer; and
identifying information on a counterpart of the financial transfer based on the information input through the popup window.

19. The method of claim 11, further comprising displaying personal information of the selected contact based on the first user input,
wherein the personal information includes a name, a phone number, a photo, and propensity information of the selected contact.

20. The method of claim 19, further comprising displaying latest news information related to the selected contact based on the first user input.
